(19) United States
(12) Patent Application Publication
(10) Pub. No.: US 2016/0092942 A1
(43) Pub. Date: Mar. 31, 2016

(54) TRANSACTION SYSTEM AND METHODS FOR INTEGRATING PHILANTHROPY AND VOLUNTEERING

(71) Applicants: Tess P. MICHAELS, Plano, TX (US); Max P. MICHAELS, Plano, TX (US)

(72) Inventors: Tess P. MICHAELS, Plano, TX (US); Max P. MICHAELS, Plano, TX (US)

(73) Assignee: SOCEANA LLC, Plano, TX (US)

(21) Appl. No.: 14/498,226

(22) Filed: Sep. 26, 2014

(51) Int. Cl. G06Q 30/02

(52) U.S. Cl. CPC G06Q 30/0279

(57) ABSTRACT

The present invention provides a system for managing charitable funds in the ecosystem of corporations, philanthropists, volunteers and non-profits that do social good. Participants may sponsor and cause to issue a finite number of alternative currency units, with varying conditions on use. These units are transferred to volunteers who are supporting a non-profit organization corresponding to the volunteer hours spent by each. The earned units may be gifted by each volunteer to any non-profit organization. Alternatively, the units may be directly granted to a non-profit by corporations and philanthropists corresponding to the units earned by each volunteer. The non-profits voluntarily accept the units and spend it to generate social good. These new methods to pledge, sponsor, issue, buy, sell, earn, store, gift and spend the alternative currency units create a vibrant, community that multiplies the social good generated.

### FIELD OF THE INVENTION

The present invention generally relates to the market for social good, the domain of corporate and individual philanthropy, where the key stakeholders are corporations, philanthropists, volunteers and non-profits. In particular, the present invention relates to a system and method to multiply the effect of the charitable contributions by creating social incentives for volunteers and economic incentives for non-profits. It includes implementing an alternative currency ecosystem in the context of charitable giving and volunteering. These new methods—to pledge, sponsor, issue, buy, sell, earn, store, gift and spend—or alternative currency units, cause to do all of the above, thereby strengthening the linkages among the stakeholders.

### DESCRIPTION OF RELATED ART

A currency, or in more general terms, money, is a unit of account, medium of exchange, and a store of value. It is an identifiable object of account having a value that is trusted and consistently honored as a payment for goods or services. Every object has two uses—the original purpose for which the object was designed and to use the object as an item to sell or barter, as a medium of exchange. Barter systems have been known for centuries, in which an individual that possesses a surplus of any object directly exchanges the object for another object. The exchanged object has the same perceived value as that of the original object. The extent to which the barter system goes is only limited to the ‘capacity of want’. In other words, the seller has to find the buyer who wants to buy his object offered for barter and who also could offer in return something the seller wants to buy, i.e., as more sophisticated objects are developed and the requirements and urgency of humans evolve, it is often impractical to implement a barter system. Further, there is no standardized measure or a governing authority involved in such a system.

Over a period of time, as human needs became more refined, indirect exchanges were encouraged and various currencies came into existence. Coins made of different metals were used as proto-money due to their durability, portability, and easy divisibility. For example, the use of gold as proto-money can be traced back to the fourth millennium BC. During the initial days, different communities used different coins as currencies, thus making trades across the communities challenging. Governments of various nations helped standardize the coinage and establish authority for recognition of currencies. Another step in the evolution of the currencies involved the change from a coin being a unit of weight to a unit of ‘value’. A distinction could soon be made between the commodity value of the coin and its specie value—the difference is often termed as the seigniorage of the coin.

As merchants and traders desired to avoid the heavy bulk of coinage in larger commercial transactions, credit notes were invented, which soon evolved into bank notes. Paper money in form of bank notes and checks soon became popular; it continues to be one of the major media of current commercial transactions. Currencies offer many advantages—they work as a medium of exchange across silos—local, regional, national, and global; they have a store of value (i.e., they can be saved, retrieved and exchanged at a later date); they often have a fixed value; they are asset backed (a creditworthy entity provides a guarantee); they are quasi-regulated (i.e., their regulation lies between self-regulation and a stricter, explicit government regulation); they are fully convertible, entail a low cost of production, and are difficult to counterfeit.

A further advancement in currency systems is the advent of electronic money, which includes the use of computer networks, the Internet, and digital stored value systems. The most common examples of electronic money systems are card-based systems and software-based systems. Electronic money is understood to be a way of storing conventional money by using electronic systems, as the original currency it was converted from. Thus, the value of the electronic money stays the same as that of the original currency.

Smart cards are an early stage example of electronic money, wherein a portable storage medium, such as a chip-based or magnetic strip-based card, is used for facilitating recognition of identity of an individual, and implementing certain security measures. In 1970, the first implementation of a microelectronic device on a plastic substrate was successfully demonstrated by Kunitaka Arimura. Subsequently, the first patent was granted in 1974 to Roland Moreno. Trials were conducted in early 80s (for example, French Bank Card Association's Blue and Green Cards). Ever since, card based systems have become prevalent. Currently, MasterCard, Visa, American Express, and the like offer credit cards, debit cards, pre-paid cards, and various other card based currency alternatives that have become an integral part of our lives.

In card based systems, there exist two forms—open systems and closed systems. In open systems, a smart card is not limited to making one particular type of transaction. The same card may be used to make different purchases, pay debts, or transfer money electronically. However, such systems are often limited by the electronic terminals that are used to validate the transactions. Even today, many small and medium businesses lack the funds and infrastructure to implement these systems and have to rely on conventional paper based money.

The unaccounted electronic money model can be typically used for all types of transactions and in many ways resembles the cash-based conventional transactions. It provides a global replacement for cash based systems. For example, Mondex, an electronic currency system that was originally developed by National Westminster Bank in United Kingdom and subsequently sold to MasterCard, enables cardholders to carry, store and spend cash value using a payment card. It is a safer and faster system as compared to cash based systems. It does not require any physical or electronic signature, a password, a PIN, or an authorization mechanism to carry out the transaction. It can be used in internet and mobile based transactions, where it is often difficult to use cash. A major disadvantage associated with such unaccounted electronic money models is that tracing and fault-auditing of transactions is impossible, thereby increasing the overall risk and reducing the traceabity of the transactions.

The accounted electronic money model overcomes some of the limitations of the unaccounted electronic money models in that it imposes a stronger control over the transactions, as archiving is made possible in this model. However, this model does not permit anonymity for it to be incorporated into web browsers.

In closed systems, the stored value cards can be used for only one purpose in one specific environment, as opposed to multiple usages offered by the open card systems. Although closed systems appear to be somewhat restrictive, they have found many applications in modern world. For example, the Octopus card offered in Hong Kong is a contactless closed system offered for public transit. An extension of this idea even allows the use of this card in local supermarkets, movie halls, parking metering systems, vending machines and so forth. However, both open and closed card based systems suffer from one or more disadvantages discussed in the foregoing, some of the most prominent disadvantages being the requirement of dedicated hardware (electronic card readers and chip-based plastic cards), possibility of theft, and lack of encryption.

For example, published US patent application serial number 2013/0,339,188, by Ebay, Inc., discloses systems and methods for giving gifts in the form of secure tokens, including software and hardware tokens, such as mobile phone based tokens or electronic smart cards. The recipient can use the token to purchase a product using a checkout though the payment provider. The purchase can be made without requiring the user to create the user's own payment provider account. In such systems, once the goods or services worth of the token amount are purchased, their value diminishes and the transaction is completed. Moreover, the requirement of dedicated hardware for facilitating such a system makes it rather restrictive.

In off-line electronic money, there is no direct interaction between the merchant and the bank at the time of a transaction. This greatly reduces the time required for validating and authenticating a transaction. While the technology involves an electronic reader, it just has to register the card. The merchant can later connect with the bank for validation of the transaction. Due to the cryptography involved in this technology (use of blind-signatures) it is fairly safe and can be implemented with fewer infrastructural requirements than that for online electronic money systems.

In recent years, in parallel with electronic money systems, alternative currency systems are being developed. Such systems present an elegant alternative to the existing fiat currency systems. Some of the recently developed alternative currency systems include digital gold currency, PayPal like online payment systems, Liberty Reserve, and the like. The backbone of these systems is the Internet. These systems are safer than most other conventional systems, as they involve software-based cryptographic security methods. Since there is often no communication between the end user and the merchant/bank, and there are no strict regulations on the Internet based transactions, efforts are being made to develop a secure industry standard. For example, MasterCard and VISA agreed to develop SET (Secure Internet Transactions) standard in order to address consumer concerns.

Canadian patent application serial number 2,354,419 by Herrenkohl et. al., discloses a participant incentive loyalty program based on alternative currency systems. It encourages participant loyalty in transactions, and includes an alternative-currency-issuing business, an alternative-currency-redeeming business, and a gateway system. The gateway system is adapted to read electronic transactions at participating businesses using payment mechanisms pre-selected by participants who wish to take advantage of the incentive system.

Alternative crypto-currencies, such as Bitcoin seek to create a virtual currency for global applications. They allow the transactions to be made in a secure environment by using some form of cryptography. Since the first implementation of Bitcoin, various cryptocurrencies have been developed that aim at implementing a distributed, decentralized and secure information economy. One of the main differences between the real money (or conventional electronic money systems) and the cryptocurrencies is that no organization or individual may accelerate, stop, slow-down, or in any way moderate/control the production of money. Only a fixed amount of currency is generated when a cryptocurrency is proposed. The “programmable” aspect of the currency is being be applied to other currencies to limit their production and preserve the value. The virtual currency has run into regulatory difficulties in many countries as it undermines the power of the governments to control the issue of fiat currency through fractional reserve banking.

For example, published US patent application serial number 2009/0,089,168 by Phyllis Adele Schneck discloses an alternative currency exchange (ACE). In this system, the alternative currencies are mapped on to the known real world currencies and maintaining an exchange rate therefor. In various embodiments of Schbeck, the alternative currencies in the form of airline miles or rewards, hotel rewards, credit card points, and cash generated from within virtual environments, such as online games, are supported. Further, PCT application serial number WO 2011/008,630, by Mehew et. al., discloses an alternative currency value exchange system which creates user accounts at an alternative currency platform. A first user makes an alternative currency exchange offer. The alternative currency exchange offer includes one or more offer terms and associated assets. The alternative currency exchange offer is extended from the first user to the second user, in response to receiving acceptance of the offer from the second user. The associated assets of the first user and the second user are verified, and in response, settlement of the alternative currency exchange offer is made. However, such system are not meant for use within the charitable giving environment where entities like non-profit organizations or non-government agencies benefit from the use of alternative currencies. The above patent applications seek to address economic and technological issues quite different from this patent application, and none of them propose a currency system and methods for integrating philanthropy and volunteering.

As the virtual currencies rise in popularity, a few start-up companies have tried to piggyback on Bitcoin by creating specialized currencies linked to Bitcoin. For example, ProCoin invites charities to register with them, and subsequently relies on the growing number of Bitcoin-enthusiasts to donate to the cause in Bitcoins. To cash in on donations, charities need an exchange to convert ProCoin to Bitcoin. As such, it is implicit that this system of charitable giving is directly exposed to the rise and fall of Bitcoin. This system is very restrictive with its focus on individual donors, and the co-dependence on an immature virtual currency reduces efficiency, increases risks and diminishes the credibility of ProCoin.

For relatively closed, especially incentive based systems with fewer participants, currency systems that build upon fiat currencies (like US dollars) promise to be more efficient. For example, an incentive based system wherein a participant accrues units of alternative currency depending upon completion of some form of community service, which can be later cashed as fiat money, has multiple merits. Firstly, the actual funding in the form of fiat currency, from the contributing entity in the system, can come later upon completion of a community project. Secondly, the money could be “programmed” to come with conditions: for instance, it might be released only if a third party certifies that the conditions are met. Thirdly, the entity volunteering to work is kept incentivized by constant accrual of the alternative currency units, which might be in a real or virtual form. Finally, the risks associated with fiat currency can also be mitigated, for example, the alternative currency when linked to a basket of currencies can serve as a hedge against inflation. It also acts as a counterbalance for the specific sector, it keeps circulating within a select ecosystem of trusted partners, reducing exposure to macroeconomic risks. Hence, besides being just an elegant alternative to the status quo, such a specialized currency system offers tangible advantages.

Currently, there is no efficient system or business method for purposeful charitable giving under all these models that satisfies the corporations and philanthropists while providing incentives to volunteers and non-profits to increase their social impact. It is this inefficiency that the present invention seeks to address by offering a novel system and associated methods that facilitate transactions of charitable funds among corporations, philanthropists, volunteers, and non-profit organizations dedicated to social causes.

### SUMMARY

In a stable ecosystem where the key players are more or less fixed and trusted, it is possible to introduce a more efficient system for managing charitable funds, which can create social impact, under several models of charitable giving.

An object of the present invention is to provide a more efficient and reliable system for managing charitable funds in the ecosystem that includes corporations, philanthropists, volunteers and nonprofits that seek to do social good.

Another object of the present invention is to provide a system wherein the corporations or philanthropists can leverage their initial spending on Corporate Social Responsibility and Social Good.

Yet another object of the present invention is to create a virtuous cycle of social good, driven by an increased visibility of actual social impact, amongst the key players in the system.

Yet another object of the present invention is to create an alternative currency unit that is programmable to have several characteristics of an exchange traded stock-option (call option with certain rights to the owner, but no obligations).

The system of the present invention is designed for the good of society—for multiplying the impact of philanthropy, and for use by a set of participants seeking to generate social good, not profits or personal income. It matches credits for volunteering, and does not provide payments for services. As per various embodiments of the present invention, donors pledge, and the system is contingent on performance by the volunteers. The matched volunteer hours can be gifted to other volunteers or paid forward as charitable contributions for encashment by accredited non-profit organizations (for instance, those with 501 statuses). The system is programmable and restricted in use, in that the money can only be earned through volunteering and the earned money can only be gifted, not spent by the volunteers for personal consumption—for purchases or for availing services.

Embodiments of the invention provide a method for facilitating transactions of charitable funds among corporations, philanthropists, volunteers, and non-profit or governmental organizations dedicated to social causes. Finite units of an alternative currency are sponsored and then issued. Each unit has a face value and a store of value associated therewith. A corporation or a philanthropist sponsors a finite number of units and causes to issue at least one alternative currency unit by paying a fee to the issuer. The at least one alternative currency unit is transferred from the corporation or the philanthropist to a volunteer based on a matching between volunteer hours accrued with the volunteer and the store of value of the alternative currency unit. At least one of the corporation and the philanthropist credits charitable funds to a non-profit organization in exchange of the at least one alternative currency unit, wherein the at least one alternative currency unit is gifted by the volunteer to a non-profit organization. The credited charitable funds are equivalent of the face value associated with the at least one alternative currency unit. Alternatively, the at least one alternative currency unit may also be transferred directly from the corporation or the philanthropist to a non-profit organization. The units are backed not by the Issuer, but the corporation or the philanthropist sponsoring it. The currency's value is supported by the volunteers and non-profits who voluntarily accept the units trusting the network of corporations and philanthropists that back the face value of these units. Once a critical mass of units is in place, the sponsors can choose to simply buy the currency already in circulation, providing liquidity to the currency.

The money could be “programmed” to come with multiple conditions: for instance, it might be released only if a third party certifies that the conditions are met, to be spent only by certain types of spenders, at specified locations, and so forth. Further, it cannot be used virtually anywhere—it can be used only within certain payment networks. For example, a corporation may match the charitable gift of an employee to a specific non-profit, after that non-profit certifies the receipt of the employee gift. Alternatively, a corporation may match the volunteering of an employee to a specific non-profit, after that non-profit certifies the hours of volunteering. For instance, Walmart Inc. may pledge to match the volunteering hours of its employees at Red Cross, to be donated to United Way, which may use it only at Sam's Club outlets using Walmart Money Card. Walmart can relax any of these conditions the as volunteers deliver on the social objectives it seeks to accomplish.

A philanthropic corporation may choose to relax the conditions and encourage its employees to do social good on a global scale by providing them with grants depending on their level of charitable contributions or volunteering, and give them the choice to gift it to non-profits of their choice. Corporations may want to promote volunteering in the broader communities they serve by tapping not only their employees but also the citizens. Foundations and Philanthropists also may want to use these models to maximize the social impact of their spending on charity by choosing any of these modes.

The proposed method and the currency (hereinafter referred to as ‘Philas’) are different from virtual currencies in four significant ways. Firstly, the currency is backed by the balance sheet or the bank accounts of the issuers. For example, if Cisco Systems is issuing $10M worth of Philas, it is backed by Cisco's $40B balance sheet, just like its corporate bonds. Secondly, Philas is to be sponsored, issued, earned, gifted and spent by a set of known and trusted players, not anonymous parties as in the case of BitCoin. Thirdly, the domain of Philas is limited to the market for social good, to be spent by nonprofits keeping it immune from commercially driven tractions. Fourthly, the value of the currency is not based on scarcity (as with BitCoin 21M total units), and would be sponsored, issued and spent depending on the growth of the market for social good; this also prevents volatility in the value of Philas due to manipulations by participants.

The proposed invention is a significant improvement over the existing methods (see prior art in Flow chart 2), and it is significantly more valuable than its building blocks as the system seeks to serve a noble purpose for the society. Ten elements are eclectically chosen, which when combined offers significant value to three kinds of users—corporations, foundations and individuals seeking to do social good—and form a vibrant community for greater good. Thus the integration is novel, unique and useful. Technological environment and a specific implementation are also illustrated (FIG. 5 and FIG. 6).

### BRIEF DESCRIPTION OF DRAWINGS

The features of the present invention—collectively termed Philas—are believed to be novel in its embodiment, and are set forth with particularity in the appended claims. Embodiments of the present invention will hereinafter be described in conjunction with the appended drawings provided to illustrate and not to limit the scope of the claims, wherein like designations denote like elements, and in which:

FIG. 1 illustrates interaction between various entities; viz., corporations, philanthropists, volunteers and non-profits (including governmental organizations), in one complete transaction cycle of the alternative currency units, in accordance with an embodiment of the present invention;

FIG. 2 is a flowchart illustrating a conventional method for facilitating transactions of CSR and SG funds among corporations, employees, and non-profit organizations dedicated to social causes, using fiat currencies, such as US dollars;

FIG. 3 is a flowchart illustrating a method for facilitating transactions of corporate social responsibility (CSR) funds or Foundation funds among corporations, philanthropists, volunteers, and non-profit organizations dedicated to social causes, using Philas, in accordance with an embodiment of the present invention;

FIG. 4 shows a matrix that shows various parameters, using which the system of the present invention can be configured or programmed for various participants thereof, in accordance with various embodiments of the present invention;

FIG. 5 is a block diagram illustrating a system for facilitating transactions of corporate social responsibility (CSR) and Social Good (SG) funds among corporations, philanthropists, volunteers, and non-profit organizations dedicated to social causes, using Philas, alternative currency units, in accordance with various embodiments of the present invention; and

FIG. 6 illustrates a schematic block diagram of an alternative embodiment of the system of the present invention.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise.

There may be additional components described in the foregoing application that are not depicted on one of the described drawings. In the event such a component is described, but not depicted in a drawing, the absence of such a drawing should not be considered as an omission of such design from the specification.

The methods would include electronic on-line payment requests from a corporation or philanthropist, and debiting a donor account for an amount corresponding to the amount of the payment request, and debiting the account of the payee—a volunteer or non-profit.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

It should be noted that the system and currency of the present invention are interchangeably referred to as Philas, Soceana, social currency, alternative currency, social good currency (SGCs), and social good currency with conditions (SGCCs) throughout this disclosure, without departing from the scope and spirit of the present invention. The Philas are units of alternative currency that are generated by the system of the present invention by using one or more embodiments of the present invention, and exhibit one or more characteristics as described in the forthcoming description.

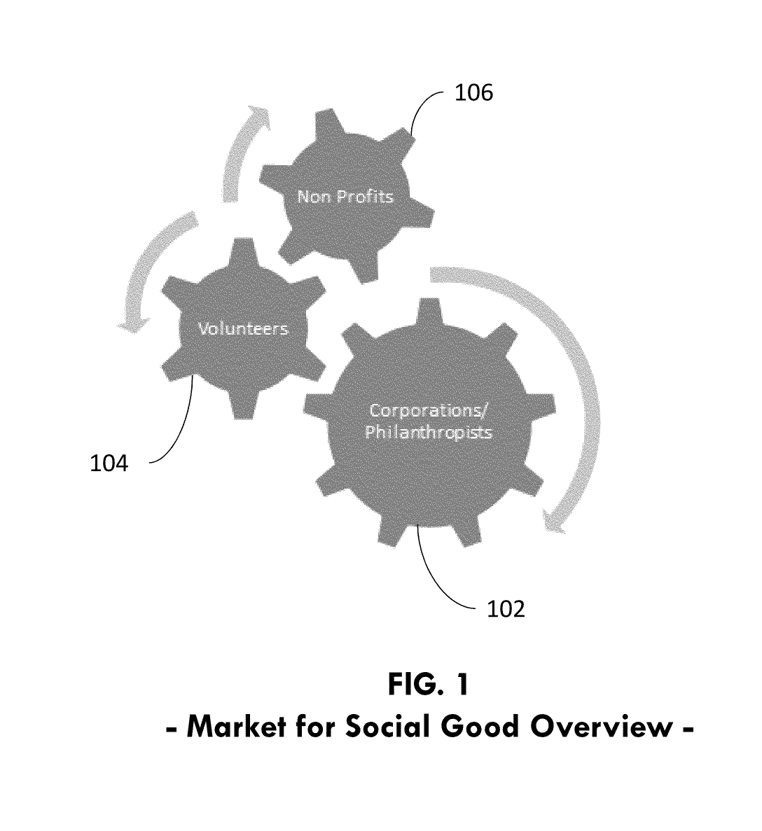

FIG. 1 illustrates interaction between various entities viz., corporations, philanthropists, volunteers and non-profit organizations, in one complete transaction cycle of Phila, in accordance with an embodiment of the present invention.

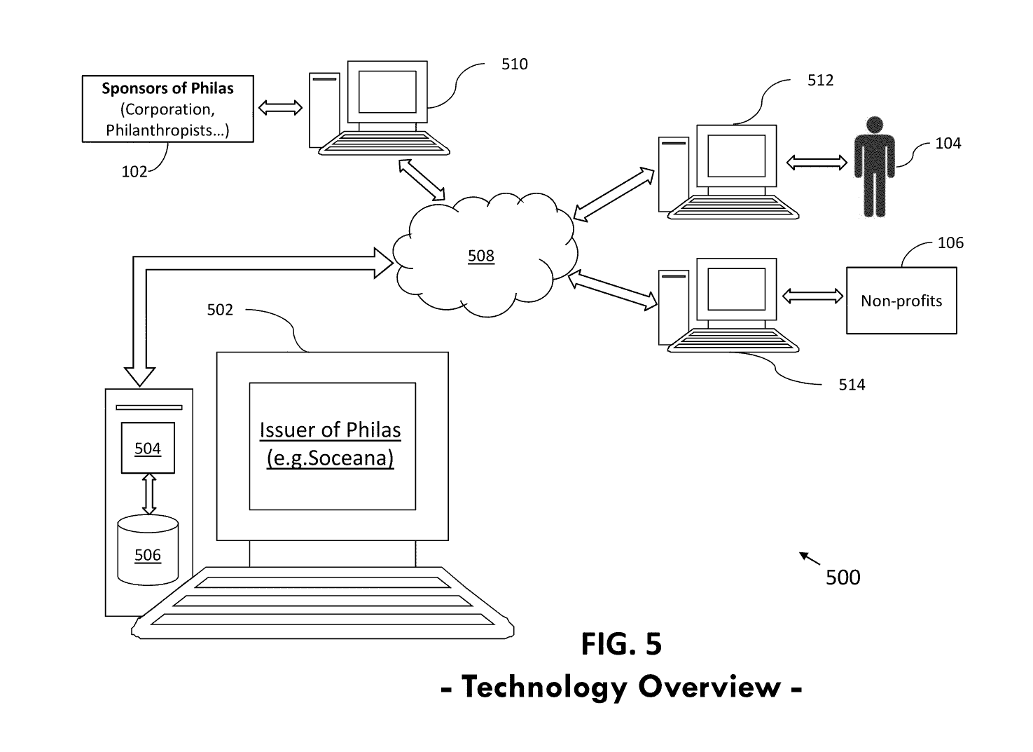

Corporations or philanthropists 102 are the primary drivers in the system. They trigger the transaction cycle by buying units of Phila from an issuer (e.g., Soceana), such as the system of the present invention (described in detail in conjunction with FIG. 5). These alternative currency units are in turn used to incentivize a volunteer 104, who can convert her volunteer hours into Philas. The volunteer has the option to gift the accrued Philas to other volunteers who can store or spend it as they choose. Volunteers can also donate Philas to a non-profit organization 106 which can encash it to a fiat currency and use the funds to further increase volunteering and on social causes that the organization 106 is working towards. Once a critical mass of units are in place, the sponsors 102 can choose to simply buy the currency already in circulation, providing liquidity to the currency.

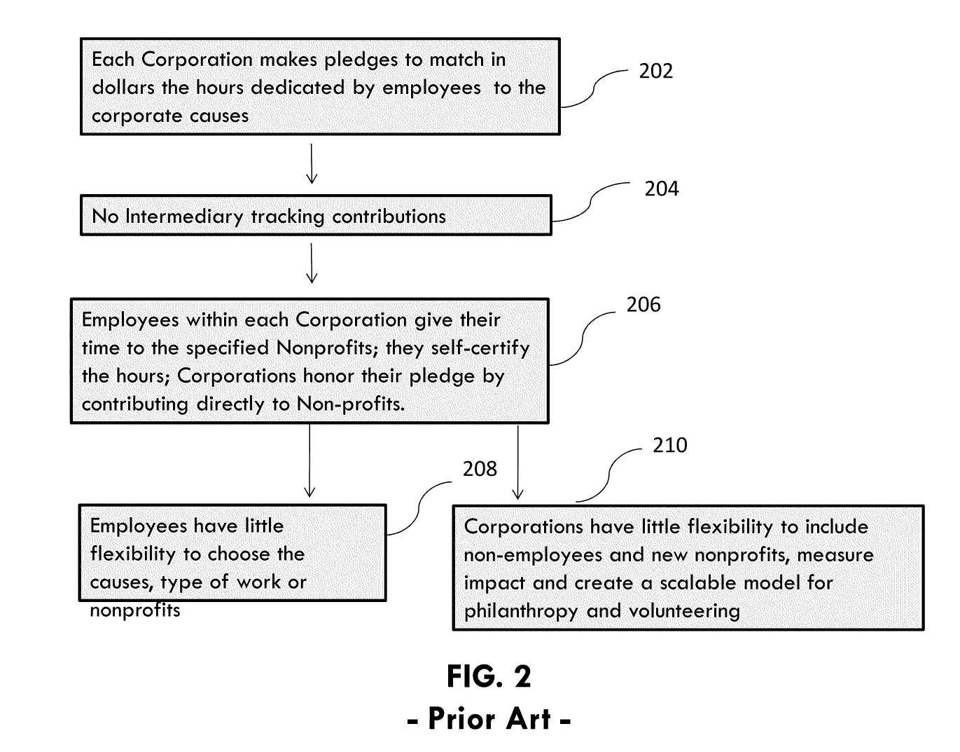

FIG. 2 is a flowchart illustrating a method for facilitating transactions of CSR and SG funds among corporations, employees, and non-profit organizations dedicated to social causes, using fiat currencies (e.g. dollars). This is a simplistic method which has several limitations including little flexibility for corporations or its employees to meet their unidentical philanthropic goals. Also it leaves out important stakeholders, such as non-employee volunteers, similar-minded corporations, and philanthropists.

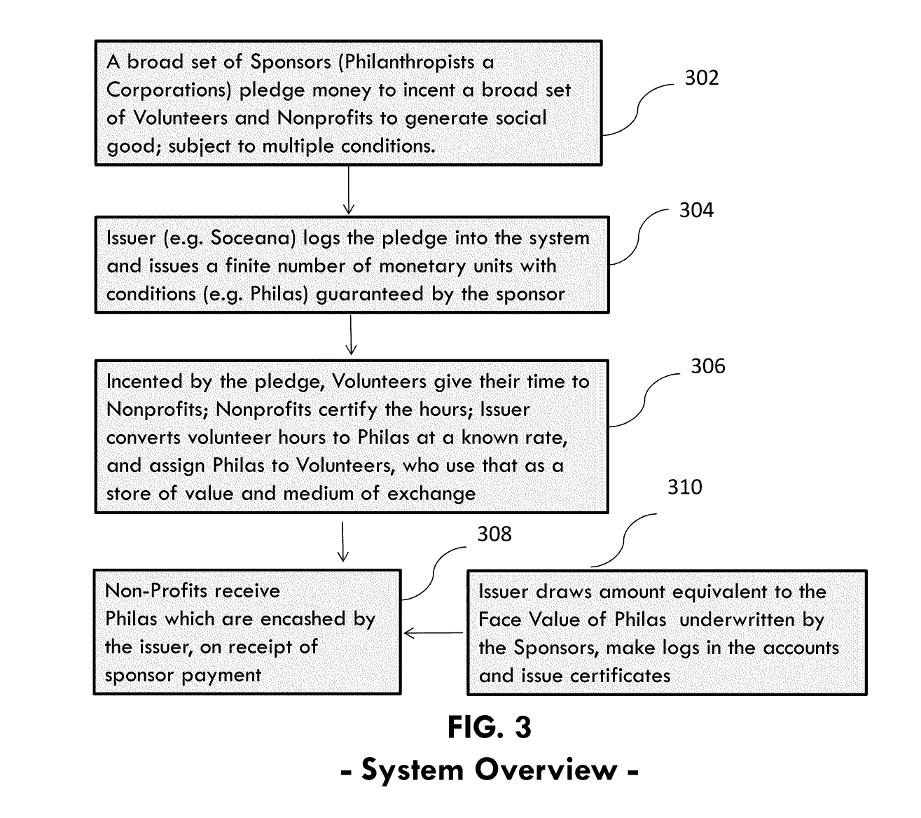

FIG. 3 is a flowchart illustrating a novel system and methods for facilitating transactions of CSR and SG funds among corporations, philanthropists, volunteers, and non-profit organizations dedicated to social causes, using Phila, in accordance with an embodiment of the present invention.

The issuer, such as the system of the present invention, issues a finite number of Philas at step 302. The sponsors 102 (e.g. philanthropists and corporations) cause to issue Philas at a fraction of their face value, at step 304. Non-profits 106 match volunteer hours with Philas according to a known conversion rate at step 306. The volunteers 104 can re-gift the earned Philas to another volunteer; however the primary purpose is to gift it to an accredited non-profit organizations 106 in the network, which can be cashed at face value from the issuer at step 308. Subsequently, the issuer draws an amount equivalent to the face value of Philas underwritten by the original sponsors 102 (philanthropists/corporations), logs all accounts in the system and issues certificates.

The Philas serve as incentive for volunteers to generate social good and help the sponsors leverage the CSR ecosystem. Every dollar the corporation 102 spends motivates somebody to volunteer and then re-gift it to a non-profit organization 106, which would in turn use the money to increase volunteering, hence creating a cycle of social good. The most important merit of this system is that the sponsors 102 do not have to pay the face value of their pledge upfront, hence creating manifold return over the course of an entire cycle.

For example, a pledge for Phila of face value $100, sponsored by paying $5 (a fraction of the face value), generates a 20-fold return in terms of social god generated by the first volunteer even before the $100 gets paid to the non-profit 106, which then sets off another virtuous cycle of social good. Hence, the spending has a “force-multiplier effect” and generates higher returns on charitable spending by corporations and philanthropists 102. The utility of such a system to all participants is apparent.

In an embodiment of the present invention, the volunteers 104 can keep the Philas as a store of value, and donate it to non-profits 106, ensuring correct channeling of the charitable funds while meeting the self-esteem and self-actualization needs of themselves.

The sponsor may cause to issue more and restrictive Philas to meet their specific philanthropic goals, however, they serve as a lasting symbol of value to the volunteers 104, of the social good generated by volunteering. Once programmed and issued, the alternative currency can take the form of a cryptocurrency or in traditional forms such as gift cards, points, coupons, air-miles or certificates.

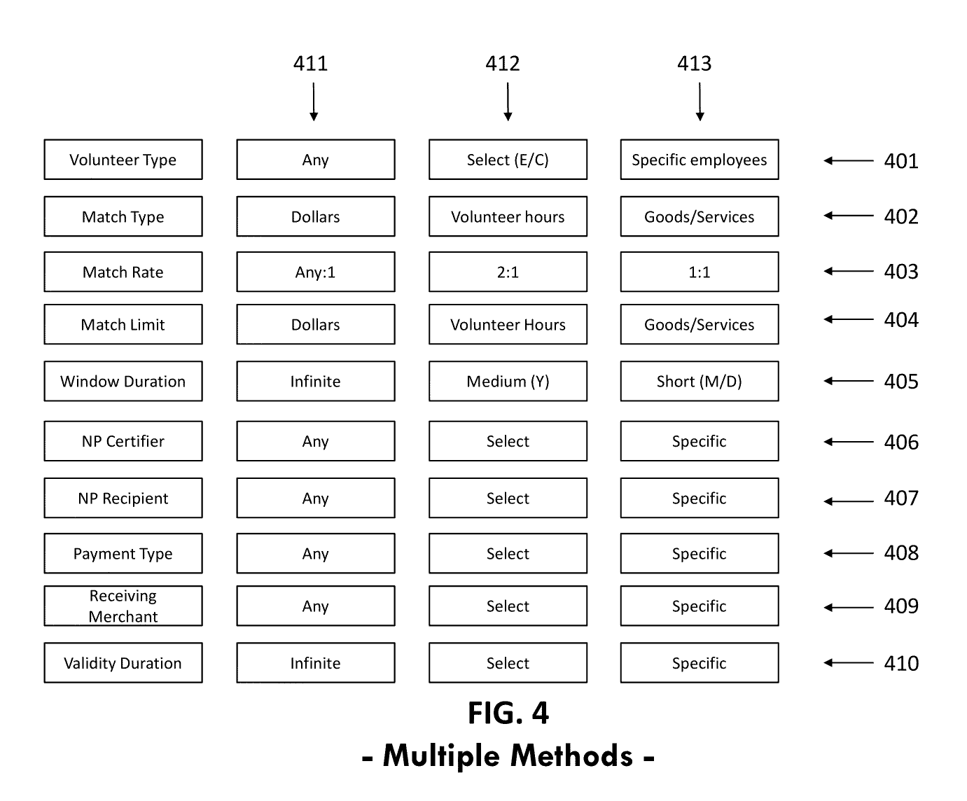

FIG. 4 shows a matrix that shows various parameters, using which the system of the present invention can be configured or programmed for the various participants thereof, in accordance with various embodiments of the present invention. As explained in the foregoing description, the participants include the donors, non-profits, and volunteers. The donors who sponsor the currency may be corporations, such as Walmart or Cisco; foundations, such as Bill & Melinda Gates Foundation, the Dell Foundation, etc.; and individuals, such as high net-worth individuals (HNIs). As can be seen from FIG. 4, there are ten rows (from row 401 through row 410) and three columns (from column 411 through column 413), in which the various parameters for programming the system are listed. For configuring the system of the present invention, ten parameters (or variables) need to be selected; and for each such parameter, there exist a number of possibilities or options. In the forthcoming description, the entire process for configuring the system of the present invention by selecting these parameters has been explained. It should be noted that while only a few possibilities are illustrated in detail, any other combinations are well within the scope of the present invention.

The row 401 lists the different volunteer types. In various embodiments of the present invention, any person that belongs to an organization, or select employees of the organization, or specific employees that meet certain criteria may be allowed to participate in the volunteering process. The participating organization (donor) has complete control over defining this parameter. For example, a corporation such as Walmart may declare that any of its employees may volunteer and the volunteered hours will be matched by Walmart for social good. Walmart may also select employees that meet certain criteria (employee's age, number of years of employment, and so forth) for matching their volunteer hours. Similarly, the row 402 lists various ‘match types’ that a corporation may choose to match. In one embodiment, dollars can be matched for only dollars. In other embodiments, dollars can be matched for volunteer hours, goods, or services. The participating donor can select one of these options while configuring the parameter.

The row 403 lists the different possible match rates that can be specified by the donors. In an embodiment, any match rate is possible, i.e., every available volunteer hour can be matched by any number of dollars. Various other embodiments allow 2:1, 1:1 or similar match rates. In the above example, Walmart may specify that for every volunteer hour by the specified volunteers, 2 dollars will be matched (2:1 scenario).

The row 404 lists the various possible scenarios for the parameter ‘match limit’. Match limit specifies the upper cap on the ‘match type’ parameter. For example, Walmart, when it chooses to match dollars, may specify that it will have a match limit of one million dollars. In other words, the match type is capped at one million dollars. Similarly, volunteer hours, goods, or services can also be capped by specifying the match limit.

The row 405 lists the various options for the ‘window duration’ parameter. This parameter specifies the time for which the currency will be valid from the time the donor matches the dollars/volunteer hours/goods/services. In various embodiments, the window duration may be infinite, in years, in months, in days, and so forth. The longer the window duration, more will be the validity of the currency.

The row 406 lists the various options for ‘non-profit certifier’. The hours clocked by the volunteers can be certified for authenticity by a non-profit certifying authority. A corporation may choose to allow ‘self-certified’ volunteer hours (‘any certifier’) or make it mandatory that the hours be certified by a non-profit certifier, such as Red Cross or any certifier from an approved list of certifiers. It may also choose to get the certification done from a specific certifier, such as United Way or World Health Organization (WHO).

The row 407 lists the various options for non-profit recipient. Once the volunteer earns the hours, the matching dollars may be received by one of these recipients. The donor may choose any non-profit to receive the money (note that the volunteers are not allowed to encash the volunteer hours in form of dollars, goods, or services). Alternatively, a recipient from a list of approved recipients, or a specific non-profit, may be designated as the recipient. Further, non-profits from a particular geography (for example, Africa or South America) or a specific sector (for example, healthcare or education) may be selected.

The row 408 lists the various options for payment types. As explained in the foregoing description, the system of the present invention supports a number of payment methods. This payment type refers to the mode using which the non-profits that receive the money are going to spend that money. For example, a debit card or gift card like instrument may be issued which is preloaded with the dollars matched by the corporation. Or an electric wallet may used which can be loaded periodically. Alternatively, the money may go into the bank account of the non-profit or have a list of options like payment gateways/providers to choose from. The row 409 lists the ‘accepting merchant’ or vendor where the non-profit organization can spend the money. Like other parameters, any option may be selected. The receiving merchant may be any merchant, a list of approved/specified merchants, or a specific merchant chosen by the donor.

The row 410 lists the Validity or Duration for which a non-profit organization can spend the money they receive. Options include infinite (any time, and forever), select (for a limited amount of time and may be for a particular day of the week, time of the day, and so forth), or on specific days, etc.

Once all the parameters are specified by the sponsor, i.e., when the system is programmed by specifying the required inputs, a currency is created which reflects the specified parameters. The selected parameters come into the eco-system of volunteers, donors and non-profit organizations. The system of the present invention supports multiple such customized eco-systems that encompass different donors, non-profits, and payment methods by keeping the central idea of charitable transactions common. This allows an integration of integrating philanthropy and volunteering through the alternative currency. These new methods to pledge, sponsor, issue, earn, store, gift or spend the alternative currency or cause to do so and strengthen the linkages among the key stakeholders—corporations, philanthropists, volunteers, and non-profit organizations.

Moreover, in some optional embodiments of the present invention, when no parameter values are specified, the system may intelligently choose the best suitable parameters for the scenario and program itself. This may be done by specifying the objectives, and the parameters based on the types of donors, their revenues and budgets, available non-profits, type of volunteer hours and so forth. A person skilled in the art would understand that some of the parameters may be made optional or various other parameters and entities can be added without departing from scope and spirit of the present invention.

In a stable ecosystem where the key players are more or less fixed, and trusted, this efficient system may be introduced for managing charitable funds, which can create social impact, under several models of charitable giving. The system of this invention is designed for the good of society—for multiplying the impact of philanthropy, and for use by a set of participants seeking to generate social good, not profits or personal income. It matches credits for volunteering, and not for payments for services. As per various embodiments of the present invention, donors pledge, and the system is contingent on performance by the volunteers. The matched volunteer hours can be paid forward as charitable contributions for encashment by accredited non-profit organizations. The system is programmable and restricted in use, in that the generated money cannot be spent by the volunteers for purchases or for availing any services. Further, unlike other currencies it may not be used virtually anywhere—it can be used only within certain payment networks.

The proposed system enables the money to be “programmed” to come with conditions: for instance, it might be released only if a third party certifies that the conditions are met, to be spent only by certain types of spenders, at specified locations. For example, a corporation may match the charitable gift of an employee to a specific non-profit, after that non-profit certifies the receipt of the employee gift. Alternatively, a corporation may match the volunteering of an employee to a specific non-profit, after that non-profit certifies the hours of volunteering. For instance, Walmart Inc. may pledge to match the volunteering hours of its employees at Red Cross, to be donated to United Way, which may use it only at Sam's Club outlets using Walmart Money Card. Walmart can relax any of these stipulations along the way as volunteers deliver on the social objectives it seeks to accomplish.

A philanthropic corporation may choose to relax the conditions and encourage its employees to do social good on a global scale by providing them with grants depending on their level of charitable contributions or volunteering, and give them the choice to gift it to non-profits of their choice. Corporations may want to promote volunteering in the broader communities they serve by tapping not only their employees but also the citizens. Foundations and Philanthropists also may want to use these models to maximize the social impact of their spending on charity by choosing any of these modes.

Referring now to FIG. 5, a schematic block diagram of a system 500 for facilitating transactions of corporate social responsibility (CSR) and Social Good (SG) funds among corporations, philanthropists, volunteers, and non-profit organizations dedicated to social causes, using Philas, alternative currency units, in accordance with various embodiments of the present invention, is shown. The system 500 includes a central server 502, incorporating the Soceana technologies to support Philas. The central server 502 includes a processor 504 communicatively coupled to a memory 506, by using an appropriate arrangement, such as a bus and various interfaces (not shown). The central server 502 is further connected to a network 508, such as a local area network (LAN), metropolitan area network (MAN), and wide area network (WAN) or the Internet, over a secured communication channel. The data sent by the central server 502 may be suitably encrypted by using one or more cryptographic techniques well known in the art.

The system 500 further includes various client devices present with the various entities dedicated to social causes. For example, in FIG. 5, client devices 510, 512, and 514 are illustrated, which are respectively present with the sponsors (corporations or philanthropists) 102, volunteers 104, and non-profit organization 106. However, it will be apparent to a person skilled in the art that many more such client devices can be connected to the central server 502 by way of the network 508, and it does not restrict the scope of the present invention in any way. The sponsors 102, volunteers 104, and non-profits 106 interact with each other by way of the central server 502 and the network 508.

The processor 504 of the central server 502 is configured to read the data from, and write the data on to the memory 506. The processor 504 is further configured to execute the method of the present invention, as described in conjunction with FIGS. 1-4. For example, the processor 504 may be configured to create (“mint”) a finite number of social currency units, Philas and store this data on to the memory. Further, a corporation or a philanthropist may sponsor the Philas at a fraction of the face value associated with it. The central server 502 then allows a transfer of the Philas from the corporation or the philanthropist 102 to a volunteer 104 based on a matching between volunteer hours accrued with the volunteer and the store of value of the alternative currency unit, as explained in the foregoing. The corporation or the philanthropist 102 credits charitable funds to a non-profit organization 106 in exchange of the Philas. The Philas may be gifted by the volunteer 104 to the non-profit organization 106 and the credited charitable funds are equivalent of the face value associated with the Philas. During this transaction, the processor 504 dynamically updates the data stored on to the memory 506 based on the details involved in the transaction.

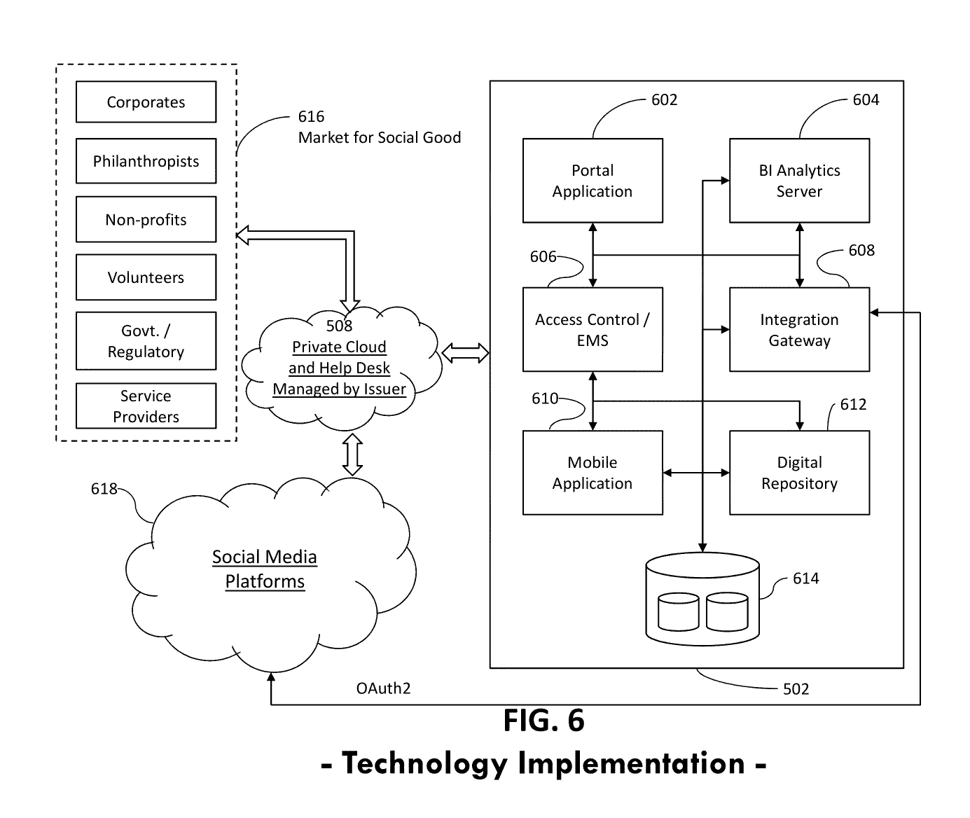

FIG. 6 illustrates a schematic block diagram of the system 500, in accordance with an alternative embodiment of the present invention. The central server 502 includes a portal application server 602, a Business Intelligence (BI) analytics server 604, an access control/EMS module 606, an integration gateway 608, a mobile application platform 610, a digital repository 612, a central database 614, and a customer support module 620. The central server 502 is connected to the network 508, such as the Internet and interacts with various entities 616 participating in the market for social good, via the network 508. Further, the central server 502 is also connected to various social media platforms 618 by way of its integration gateway 608.

616 represents the participants or entities in the market for social good. It covers all the participants in the domain of corporate and individual philanthropy, including corporate social responsibility (CSR) and social good (SG), where the key stakeholders are corporations, philanthropists, volunteers, non-profits, governmental organizations, regulatory bodies (e.g. authorities who approve tax deductions) and service providers (eg. Marketing companies).

The portal application server 602 is configured to generate and host a portal that implements the methods of the present invention, such as a web based portal or a website. The portal serves as a front end (User Interface) for the various entities in the market for social good 616. Similarly, the mobile application platform 610 is configured to generate and host a mobile based application that serves as the user front end of user interface. A suitable graphical user interface (GUI) may be generated by the portal application server 602 and the mobile application platform 610. The portal application server 602 and the mobile application platform 610 may be implemented by using a suitable technology, such as jBOSS application server technology, Android, iOS, Linux, Unix, and the like.

The Access Control/EMS module 606 provides selective restriction of access to a place or other resource. The act of accessing may mean consuming, entering or using permission to access a resource. The enterprise management system (EMS) of 606 consists of systems and applications for managing and monitoring applications and network elements of the IT infrastructure.

The integration gateway 608 is communicatively coupled to the portal application server 602, the mobile application platform 610, the access control/EMS module 606, the BI analytics server 604 and facilitates the interaction of these components with the social media platforms 618. In an embodiment of the invention, the integration gateway is implemented by using a suitable services integration technology, such as jBOSS Fuse or Apache ServiceMix. It should be noted that the examples mentioned herein are for illustrative purpose. Any other suitable integration technology that handles various protocols and supports the services may also be used. Further, an appropriate authentication mechanism, such as OAUTH or OAUTH2 may be integrated between the integration gateway 608 and the social media platforms 618.

The BI Analytics server 604 builds, schedules, secures, and distributes interactive, production-ready reports for various predictive analytics related to the method of the present invention. In various implementations, the BI analytics server 604 may be implemented by using a suitable technology, such as, but not limited to, Jasper BI express, Eclipse BIRT, Jasper Reports, Pentaho, SpagoBl, Palo, and the like.

The customer support module 620 implements appropriate customer support methods for the various participants 616. For example, the customer support module 620 may implement voice, chat, video, or multimedia based interaction with a customer support executive. The customer support executive may be a human or a machine. For example, in various implementations, system such as Verint, Parature, Oracle, and the like.

Various components of the systems (Philas) described above may be implemented in the form of software, a firmware, hardware or combinations thereof. The systems, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system includes a computer, an input device, and a display unit, and communicates over the Internet. The computer can incorporate a microprocessor. The microprocessor can be connected to a communication bus. The computer can also include a memory. The memory may include Random Access Memory (RAM) and/or Read Only Memory (ROM). The computer system can further incorporate a storage device. The storage device can include a hard disk drive or a removable storage drive, such as a floppy disk drive and/or an optical disk drive. Storage device can also be other similar means for loading computer programs or other instructions into the computer system.

The computer system executes a set of instructions that are stored in one or more storage elements, in order to process input data. The storage elements may also hold data or other information as required. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. The term logic may include, by way of example, software or hardware and/or combinations of software and hardware.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for facilitating transactions of charitable funds among corporations, philanthropists, volunteers, non-profit organizations, and governmental organizations, the method comprising:
creating finite units of an alternative currency, wherein each unit has a face value and a store of value associated therewith;
allowing a corporation or a philanthropist to sponsor, pledge and guarantee at least one alternative currency unit from the finite number of alternative currency units, wherein the at least one alternative currency unit is sponsored at a fraction of the face value associated with the at least one alternative currency unit;
allowing a transfer of the at least one alternative currency unit from the corporation or the philanthropist to a volunteer based on a matching between volunteer hours accrued with the volunteer and the store of value of the alternative currency unit; and
facilitating at least one of the corporation and the philanthropist to credit charitable funds to a non-profit organization in exchange of the at least one alternative currency unit, wherein the at least one alternative currency unit is gifted by the volunteer to another volunteer or to a non-profit organization, and wherein the credited charitable funds are equivalent of the face value associated with the at least one alternative currency unit.

2. The method of claim 1, further comprising associating one or more conditions to the alternative currency unit to meet one or more social purposes.

3. The method of claim 1, wherein the alternative currency unit is pledged, sponsored, guaranteed, and programmed by at least one of the corporation and the philanthropist.

4. The method of claim 1, wherein the alternative currency units are directly granted to the non-profit organization by at least one of the corporation and the philanthropist corresponding to units earned by the volunteer.

5. The method of claim 1, wherein the alternative currency units in circulation may be bought and sold among the participants in the market for social good, providing liquidity for the alternative currency units.

6. The method of claim 1, further comprising allowing cashing of the transferred at least one alternative currency unit by the volunteer to other volunteers or to non-profits engaged in charitable purposes.

7. The method of claim 1, further comprising disallowing cashing of the at least one alternative currency unit by the volunteers for personal consumption.

8. The method of claim 1, further comprising allowing cashing of the at least one alternative currency unit only by the non-profit organization and only for social good activities.

9. The method of claim 1, wherein the alternative currency includes one of a crypto-currency, a gift-card, a plurality of points, a certificate, a plurality of air-miles, and a coupon.

10. The method of claim 1, wherein the alternative currency unit includes one or more multiple distinguishing characteristics.

11. The method of claim 10, wherein the multiple distinguishing characteristics include one or more of an issuer type, a volunteer type, a match type, a match rate, a match limit, a duration, a certifier, a recipient, a payment type, a participating merchant, and a validity of currency units.

12. A system for facilitating transactions of charitable funds among corporations, philanthropists, volunteers, non-profit organizations, and governmental organizations dedicated to social causes, the system comprising:
a central server comprising a processor and a memory coupled to the processor, wherein the processor is configured for:
creating finite units of an alternative currency, wherein each unit has a face value and a store of value associated therewith;
storing data associated with the alternative currency on to the memory;
allowing a corporation or a philanthropist to sponsor at least one alternative currency unit from the finite number of alternative currency units, wherein the at least one alternative currency unit is sponsored at a fraction of the face value associated with the at least one alternative currency unit;
allowing a transfer of the at least one alternative currency unit from the corporation or the philanthropist to a volunteer based on a matching between volunteer hours accrued with the volunteer and the store of value of the alternative currency unit,
wherein, at least one of the corporation and the philanthropist credit charitable funds to a non-profit organization in exchange of the at least one alternative currency unit, wherein the at least one alternative currency unit is gifted by the volunteer to the non-profit organization, and wherein the credited charitable funds are equivalent of the face value associated with the at least one alternative currency unit; and
updating the data stored on to the memory based on at least the sponsorship of the alternative currency unit, the transfer of the alternative currency unit, the credit of the charitable funds, and the gifting of the alternative currency unit.

13. The system of claim 12 further comprising:
one or more client computers, each with the corporation, the philanthropist, the volunteer, and the non-profit organization, wherein each client computers is communicatively coupled to the central server and the corporation, the philanthropist, the volunteer, and the non-profit organization transact with the central server by way of a corresponding client computer.
